(19) United States
(12) Patent Application Publication
(10) Pub. No.: US 2020/0053966 A1
(43) Pub. Date: Feb. 20, 2020

(54) METHOD FOR STIMULATING PLANT DISEASE SUPPRESSIVE ACTIVITY IN SPHAGNUM MOSS, RELATED PRODUCTS AND USES

(71) Applicant: LUONNONVARAKESKUS, Helsinki (FI)

(72) Inventors: Risto TAHVONEN, Piikkiö (FI); Liisa SÄRKKÄ, Littoinen (FI); Kari JOKINEN, Helsinki (FI); Juha NÄKKILÄ, Kaarina (FI)

(21) Appl. No.: 16/610,057

(22) PCT Filed: May 4, 2018
(86) PCT No.: PCT/EP2018/061456

§ 371 Date: Oct. 31, 2019

(30) Foreign Application Priority Data
May 8, 2017 (FI) 20175402

(51) Int. Cl. A01G 7/06; A01G 24/28; A01N 25/12; A01N 65/44; C05F 11/02

(52) U.S. Cl. CPC A01G 7/06; A01G 24/28; A01G 24/23; A01N 65/44; C05F 11/02; A01N 25/12

(57) ABSTRACT

A method for stimulating plant disease-suppressive activity, such as soil—and seed-borne fungal diseases—and saprophytic molds-suppressive activity, in Sphagnum moss biomass is provided. In the method freshly harvested and/or air-dried Sphagnum biomass is heat treated, thereupon a flow of air heated to a temperature within a range of 50-80° C. is conveyed thereto during a predetermined period of time. Sphagnum biomass is preferably selected from naturally occurring Sphagnum species, in particular, Sphagnum fuscum. A plant disease-suppressive growing medium and uses thereof are further provided.

### FIELD OF THE INVENTION

The present invention generally relates to methods of processing biomass in order to produce growth substrates for plant cultivation. In particular, the present invention concerns a heat treatment method of moss biomass, such as Sphagnum moss biomass; thereupon a variety of products with pronounced fungistatic effect can be obtained. The invention further relates to a moss-derived growth substrate and use thereof in prevention and control of harmful moulds and plant diseases.

### BACKGROUND

Plant cultivation is influenced by various factors, such as soil quality, water availability, and environmental conditions. Use of growth substrates for cultivation of agricultural and horticultural crops, including that in greenhouses, constitutes an effective tool for controlling and improving the environment surrounding the plants; thereby, exploitation of various growth substrates (growing media) is an established practice in plant cultivation, Choice of a growth substrate is typically governed by its physical and chemical properties, suitability for recycling and/or potential plant disease-suppressive activities.

In terms of sustainability, there is a general tendency for preference of organic growth substrate materials, since reclamation of inorganic substrates, such as mineral wool (e.g. Rockwool) is generally not as straightforward as compared with that of organic materials, and may further be a subject of special requirements.

Peat, also referred to as peat moss or Sphagnum peat moss, is one of the most abundant organic materials for producing growth substrates because of its slow degradation rate, low bulk density, high porosity, high water retention capacity, etc. Peat is a sedentary deposit harvestable from bogs, marshlands and mires and consisting predominantly of dead, partly decomposed plant material. Dried peat is often referred to as turf. Peat-derived growth substrates also demonstrate plant disease-suppressive characteristics associated with anti-pathogenic activities of microbial populations, such as Streptomyces sp., present in peat.

However, despite of the benefits obtained from its use, availability of peat in future is uncertain because of its generally non-renewable nature implied by extremely slow renewal rate. As the volume of global peatlands has been continuously decreasing, some European countries have initiated conservation of their peatlands; that could result in an increased demand and rising costs for peat unless a viable and cost-effective alternative is available. The problem is further aggravated by the fact that attempts to treat peat-derived growth substrates intended for re-use by heat- or steam result in fast development of mould, mildew and various fungi-originated diseases in said substrates.

Sphagnum moss, a genus incorporating a plurality of species (Sphagnum sp.), is a plant that grows on the top of bogs, marchlands and mires. In fact, decomposition of marshland vegetation, including Sphagnum mosses, in an absence of oxygen gives rise to formation of peat, according to what is discussed hereinabove. Unlike peat, Sphagnum moss is a living and constantly renewable material with renewal rate about 30 years. Finland, for example, hosts about 300,000 ha (hectares) of marshlands that have neither conservation- nor forestry production value. Estimated rate for the production of Sphagnum moss-derived. growth substrates is thereby 15-20 million cubic meters per year.

That Sphagnum mosses can be utilized in formation of growth substrate structures has been demonstrated in the International application publications WO 98/56232 (Pelletier et al), and WO 2015/044526 (Erkkilä et al). Cited references provide no data on resistivity to plant pathogens for said growth substrates. However, insofar as recently, general presumption and even an established view was that heat- or steam treatment of wet Sphagnum moss-derived feedstocks causes the same effect as discussed above for peat-derived growth substrates, i.e. fast spreading of mould and fungi-originated diseases therewithin.

In this regard, it would be desirable to complement and. update the field of technology related to processing of renewable Sphagnum moss-derived biomass and to develop sustainable and feasible methods for formation of growth substrates therefrom for use in agriculture, horticulture and forestry at present-day and in the future. Moreover, especially in conditions of the Nordic countries it appears essential to develop growth substrates with an improved resistance to fungus diseases and mould.

### SUMMARY OF THE INVENTION

An objective of the present invention is to at least alleviate each of the problems arising from the limitations and disadvantages of the related art. The objective is achieved by various embodiments of a method for stimulating plant disease-suppressive activity in Sphagnum moss biomass, related products and uses thereof. Thereby, in one aspect of the invention a method for stimulating plant disease-suppressive activity in Sphagnum moss biomass is provided, according to what is defined in the independent claim 1. In said method Sphagnum moss biomass is heat treated, thereupon a flow of air heated to a temperature within a range of 50-80° C. is conveyed to Sphagnum moss biomass during a predetermined period of time.

In some embodiments, said Sphagnum moss biomass is freshly harvested and/or allowed to air-dry at a temperature less than 50° C. prior to heat treatment.

In some embodiments, the time period for heat treatment of Sphagnum moss biomass is 0.01-24 hours.

In some embodiments, the method further comprises subjecting Sphagnum moss biomass to size reduction prior to heat treatment, thereupon a fibrous particulate with particle size at most 40 mm is formed. In further embodiments, the method comprises classifying thus obtained fibrous particulate by particle size thereof to form a number of fractions with particle size distribution within any one of the: 2-4 mm, 4-8 mm, 8-20 and 20-40 mm. In still further embodiments, the method comprises subjecting heat treated Sphagnum moss biomass to size reduction, thereupon a powder with particle size distribution 0.1-2 mm is formed.

In some embodiments, Sphagnum moss biomass is selected from naturally occurring Sphagnum species and naturally occurring mixed Sphagnum moss community blends. In preferred embodiment Sphagnum moss biomass essentially consists of Sphagnum fuscum.

In some embodiments, Sphagnum moss biomass essentially consists of vegetative parts of Sphagnum moss plants occurring at a depth between about 30 cm and about 10 cm.

In some preferred embodiment, the method provides for stimulating at least fungal disease- and mould-suppressive activity.

In another aspect of the invention a plant disease-suppressive growing medium is provided, according to what is defined in claim 11. The plant disease-suppressive growing medium comprises Sphagnum moss biomass stimulated by the method of the previous aspect and provided in the form of a fibrous particulate or a powder with particle size at most 40 mm.

In some embodiments, said plant disease-suppressive growing medium is provided in the form of a fibrous particulate having particle size distribution selected from the group consisting of: 2-4 mm, 4-8 mm, 8-20 mm and 20-40 mm. In some further embodiments said plant disease-suppressive growing medium is provided in form of a powder with particle size distribution within 0.1-2 mm.

In some embodiments, the plant disease-suppressive growing medium comprises Sphagnum moss biomass selected from naturally occurring Sphagnum species and naturally occurring mixed Sphagnum moss community blends. In preferred embodiment Sphagnum moss biomass essentially consists of Sphagnum fuscum.

In some further embodiments, the plant disease-suppressive growing medium further comprises an at least one additive selected from the group consisting of: nutrients, fertilizers, such as calcium carbonate and/or magnesium carbonate, biochar, bio-ash, peat, bark, sawdust, clay, perlite, binders, surfactants, or any combination thereof.

In a further aspect of the invention a seedbed is provided, according to what is defined in claim 17. The seedbed comprises the plant disease-suppressive growing medium according to some previous aspect.

In still further aspect of the invention use of the aforesaid plant disease-suppressive growing medium as a fungus-, mould- and/or mildew prevention agent is provided, according to what is defined in claim 18.

In still further aspect of the invention use of the plant disease-suppressive growing medium as an insulating material is provided, according to what is defined in claim 19.

The utility of the present invention arises from a variety of reasons depending on each particular embodiment thereof. Primarily, the invention generally aims at providing a compensatory for peat, as a plant cultivation substrate with marked anti-pathogenic functionality. It is clear that increased use of peat in agriculture, horticulture, etc. leads to a rapid depletion of marshlands causing substantial amounts of carbon dioxides gases to be released into the atmosphere. Loss of valuable peatlands due to peat harvesting is irreversible; therefore, a number of European countries, such as Germany, Austria, Great Britain and Switzerland, for example, have initiated programs that limit peat harvesting from bogs.

Hence, due to a renewable nature of the Sphagnum moss biomass and profuse amounts thereof available in Finland, the invention disclosed hereby provides for a practical and cost-effective alternative to peat.

The method and the product(s) disclosed hereby possess pronounced suppressive activity against fungal diseases and moulds, in particular, saprophytic moulds. Saprophytic mould is a group of moulds that live by decaying dead organic material, such as wood, paper, etc. General consequence is an improved condition of cultivated plants, in terms of an amount and weight of just emerged and/or undamaged seedlings, growth rate and crops' quality obtainable thereby. It is apparent that efficient pest control allows for reliable and economically viable plant cultivation, therefore, the invention is also beneficial in terms of attaining monetary gain.

Furthermore, the invention provides for manufacturing a variety of growing media related products, including, but not limited to solid-, semi-solid and fluidic growth substrates (seedbeds), as well as particulate- and powdered products. In fact, the invention allows for producing a plethora of growing media related products suitable for application onto soil or any other growth substrate by admixing, spreading or layering, wherein all said products are imparted with pronounced plant disease-suppressive functionality. Such versatility enables effective exploitation of the growing media disclosed hereby on the vast areas (e.g. fields, woodlands), in greenhouses, in industrial horticultural cultivation areas, in household gardens, and the like.

In addition to the aforesaid growth substrates also other fungi- and/or mould-resistive products can be advantageously produced, such as a variety of insulating materials for buildings, for example. Saprophytic moulds are common contaminants for the indoors and pose severe health problems to people; therefore, provision of insulators that prevent proliferation and growth of said moulds is of primary importance.

The term “biomass” (Sphagnum biomass) is utilized in present disclosure with regard to overground vegetative matter harvestable from Sphagnum bogs on renewable basis.

The term “fungistatic” is utilized in the present discloser to indicate inhibition of growth and proliferation of fungi, as well as saprophytic mould and related fungal diseases caused thereby. In the present disclosure the term “fungistatic” equals with the expression “anti-fungal”.

Different embodiments of the present invention will become apparent by consideration of the detailed description.

### DETAILED DESCRIPTION OF THE EMBODIMENTS

Sphagnum moss, hereafter Sphagnum , a plant that grows on the top of a (decomposed) peat layer occurring in bogs, marshland and mires represents a valuable resource for producing various growing media and growth substrates due to its renewable nature and biological characteristics, such as an ability to prevent fungus- and mould from spreading. Sphagnum carpet layer typically reaches 20-30 cm in height.

The porosity of Sphagnum carpets is very high (exceeds 0.90), and it has correspondingly high water storage capacity. Hence, one of the conditions for producing growing media from harvested Sphagnum biomass feedstocks is at least partial dehumidifying (removal of moisture) thereof typically achieved by air-drying. Air-drying is a drying method, wherein air-exposed biomass is allowed to dry to such an extent that no further moisture is given up on exposure to air. Air-drying is performed at a temperature sufficiently low (about 20-35° C.), thereupon antifungal properties of harvested Sphagnum biomass feedstocks are largely preserved essentially the same as in the living Sphagnum carpets. Harvested biomass may be air-dried directly on the site of biomass collection (outdoors) and/or in a storage facility (indoors). In some instances, pre-drying of moss biomass may occur already prior to collection thereof, e.g. at sunshine, Especially during dry summer seasons the temperature in a top layer of living Sphagnum carpets may reach about 40° C. or even higher. The present invention utilizes air-dried Sphagnum biomass as positive control in the experimental trials described hereinbelow (see Examples).

Thus, in a number of trials said air-dried Sphagnum biomass (positive control) was admixed to a peat-derived growth substrate (Grow Board by Kekkilä) such that the content of said air-dried Sphagnum biomass constituted 25 vol-% and 50 vol-%. It was observed that the latter sample (50 vol-%) completely prevented and the former sample (25 vol-%) markedly reduced growth of cinnamon mould. (peat mould) on said growth substrate (see also Example 1).

However, effects of dehumidifying/drying Sphagnum biomass feedstocks at higher temperatures had not received particular attention so far, Instead, general presumption and even an established view existed that conventional steaming and/or heating methods (conducted at about 100° C.) will result, in mosses, in the same effect previously observed in peat, peat-based growing media and related mulches, i.e. in fast spreading of mould and fungi-originated diseases therewithin. In order to investigate the outlined problem a number of experimental trials were initiated, related to dehumidifying/drying Sphagnum biomass feedstocks at various temperatures.

Present invention pertains to a surprising outcome of these trials, thereupon the inventors experimentally proved that biological effects implied to the Sphagnum biomass by heat-induced drying deviate from that described for peat-based growing media.

In one aspect of the invention a method for stimulating plant disease-suppressive activity in Sphagnum moss biomass is provided, in which method Sphagnum biomass is heat treated, thereupon a flow of air heated to a temperature within a range of 50-80° C. is conveyed to the Sphagnum biomass during a predetermined period of time.

Thus, upon subjecting harvested Sphagnum biomass to heat treatment, according to the method provided hereby, said Sphagnum biomass demonstrates prominent increase in plant disease-suppressive activity, in particular, in that related to suppression of fungal diseases and suppression of saprophytic moulds growth.

Heat treatment is preferably apparatus-assisted and can be carried out in a conventional heating oven/an incubator with a function of air supply and circulation. Exposure of heat treated biomass material to freely circulating air allows for unobstructed moisture evaporation therefrom and appears to be of particular importance for attaining the effect disclosed hereby. Heating apparatuses with rotary chambers can also be utilized.

Hence, in the course of investigation it was observed that upon heat treatment in an open container at temperatures below 50° C., in particular, at 40-45° C., plant disease-suppressive activity of said Sphagnum biomass preserved the same as compared its natural biological characteristics, previously studied in air-dried mosses at about 20-25° C. (positive control(s)).

However, upon heat treatment at temperatures within 50-80° C. and, in particular, at about 70° C., in conditions allowing for unobstructed moisture evaporation, said Sphagnum biomass surprisingly demonstrated markedly improved plant disease-suppressive activity (see Examples 2, 6 and 8). Most prominent results were achieved by conveying a flow of heated air to and/or through said Sphagnum biomass.

In exemplary trials, in Sphagnum biomass heat treated at 70° C. in an open container a greater number of emerging cauliflower seedlings was observed in comparison to that observed in Sphagnum biomass treated at temperatures below and above 70° C. within the indicated range of 50-80° C. However, in Sphagnum biomass heat treated at 70° C. in a closed/sealed. container mould development caused by Penicillium sp. was observed in 3 days.

In further trials cucumber seeds were planted into Sphagnum biomass heat treated at various temperatures within the range of 40-70° C. in open- and closed containers, followed by inoculation with Pythium ultimum fungus thereto known to cause so called damping-off and root-rot diseases. In the samples containing Sphagnum biomass heat treated in a closed. container cucumber seedlings failed to emerge. However, in the samples containing Sphagnum biomass heat treated in an open container, as well as in the samples containing untreated air-dried Sphagnum biomass (positive control), multiple seedlings were observed. In the samples containing Sphagnum biomass heat treated at 70° C. in an open container all seeds produced seedlings that remained alive for about 2 weeks, but in the samples containing Sphagnum biomass heat-treated at room temperature (20-25° C.) only a half of planted seeds resulted in seedlings and even those suffered damping-off immediately after emergence.

Nonetheless, the above mentioned plant disease-suppressive activity stimulating effect vanishes upon further temperature increase above 80° C. Heat treatment in an absence of circulating air (e.g. in a closed/sealed container) does not yield the aforesaid suppressive effect either, resulting in fast proliferation of fungus- and/or mould.

Additionally, in the trials where dehumidifying was prevented or slowed down, because of an excessive thickness of the Sphagnum biomass layer subjected to heat treatment, for example, plant disease-suppressive activity stimulating effect vanished completely or partially (Examples 7 and 8). Thus, in Examples 7 and 8 Sphagnum biomass batches were heat treated in large (10 L) containers, thereby even after the heat treatment the lowest biomass layer remained moist and the effect attained from such heat treatment differed from the one attainable for the web-bottomed pots (Example 4) or for the small (3 L) containers (Example 6). Thus, adjusting process conditions and batch size to allow Sphagnum biomass drying sufficiently quickly in the course of heat treatment results in preserving the plant disease-suppressive activity of said heat treated biomass the same or greater as compared to the positive control (Examples 4 and 6).

These data supported by experimental results presented hereinbelow (see Examples 2, 6 and 8) unambiguously indicate that induction of plant disease preventive functionality in Sphagnum biomass occurs within the temperature range of 50-80° C. and in condition of unobstructed air supply.

It is essential that the Sphagnum biomass treated by the method of the present invention preserves its plant disease-suppressive activity stimulating effect when used as a supplement/an additive, i.e. upon being applied, by admixing or distribution, onto conventional growth substrates, such as peat-derived substrates and mulches, for example. The plant disease-suppressive effect imparted by aforesaid supplements/additives is comparable with that observed in naturally occurring air-dried Sphagnum biomass, Beneficial effects of such supplements/additives are described in Example 7.

In addition to what is described in Example 7, admixing Sphagnum biomass heat treated at 70° C. into disinfected peat in an amount of 10 vol-%, followed by seeding cauliflower seeds pre-infected by fungus Alternaria into the resulted blend, demonstrates disease-reducing effect similar to that described in Example 1, In particular, the aforementioned result is comparable to the one attained by admixing air-dried Sphagnum biomass (positive control) to a peat-derived growth substrate (Grow Board by Kekkilä) at a concentration 25 vol-%, which sample markedly reduced growth of cinnamon mould (peat mould) on said growth substrate.

In preferred embodiments, the Sphagnum biomass feedstock can be freshly harvested and/or allowed to air-dry at a temperature less than 50° C. prior to heat treatment. Thus, air-drying may occur prior to harvesting (e.g. at sunshine) or thereafter. The results shown in Example 9 confirm that air-dried and heat treated Sphagnum biomass demonstrate pronounced plant disease-suppressive activity.

It is further preferred that initial moisture content in said Sphagnum biomass is 10-75 percent by volume (vol-%). By initial moisture content it is referred to moisture (hereby, water) content in harvested Sphagnum biomass prior to heat treatment, In order to attain the above mentioned moisture content, prior to heat treatment Sphagnum biomass is allowed to air-dry at a temperature less than 50° C., in particular, at 20-40° C., Additionally, freshly harvested Sphagnum biomass can be subjected directly to heat treatment without pre-drying (air-drying). It is still advantageous that initial moisture content of freshly harvested Sphagnum biomass subjected to heat treatment does not exceed 90 vol-%; in such a case pre-drying (air-drying) is required.

Alternatively or additionally, moisture content can be adjusted to reach the aforesaid values by subsequent wetting pre-dried Sphagnum biomass. The latter approach is applicable when pre-dried moss feedstock is delivered from elsewhere (as pre-drying facilitates transportation) to a facility, in which the method disclosed hereby is carried out.

Thus, Sphagnum biomass with moisture content 10-15 vol-% is referred to in the present disclosure as “air-dry” (dried to an extent that no further moisture can be given up on exposure to air). Moisture content 75 vol-% constitutes field capacity for Sphagnum biomass, whereas moisture content 35 vol-% corresponds to irrigation threshold (moisture threshold) thereof (see Example 8).

It is essential that the method disclosed hereby can be advantageously used to stimulate plant disease-suppressive activity in Sphagnum biomass feedstocks with varying moisture content, including so called air-dry biomass material (with moisture content 10-15 vol-%), relatively “wet”/water-saturated biomass material (with moisture content up to 75 vol-%), as well as in biomass with intermediate moisture content, wherein both water-saturated and intermediate feedstocks can correspond, in terms of moisture content, to freshly harvested Sphagnum biomass. Utilization of pre-dried (air-dried) Sphagnum biomass feedstocks may be preferred in terms of cost-effectiveness and safeguarding maximum results.

In the method disclosed hereby the time period for heat treatment of Sphagnum moss biomass constitutes 0.01-24 hours (h). Shorter time periods (0.01-1 h) may be referred to as an impact heating (flash heating), thereupon treatment temperature may be increased up to 75-80° C. Exemplary flash heating time periods include, but are not limited to: 1 s, 5 s, 10 s, 30 s, 1 min, 2 min, 5 min, 10 min, 15 min, 20 min, 25 min, 30 min, 45 min, and 60 min. On the other hand, longer time periods (6-24 hours) may be applicable for temperatures 60-70° C. Such exemplary time periods include, but are not limited to: 6 h, 7 h, 8 h, 10 h, 12 h, 14 h, 16 h, 18 h, 20 h and 24 h. Other examples relate to “intermediate” treatment periods and include, but are not limited to 2 h, 3 h, 4 h, and 5 h. Time- and temperature related parameters exploited in heat treatment largely depend on moisture content in Sphagnum biomass feedstocks and are adjustable on case-by-case basis.

Trials were conducted with air-dried (pre-dried) Sphagnum biomass heat treated 0 h and 12 h at 50, 60, 70 and 80° C. Heat treated batches were infected by seed-borne damping-off disease caused by Alternaria (for cauliflower trials) and by soil-home damping-off and root-rot disease caused by Pythium (for cucumber trials). Healthy (non-infected) plant populations in untreated peat and infected plant populations in disinfected (inactive) peat were used as controls. For cucumber it was observed that in the non-infected control all plants (5 plants per test square) were healthy, whereas in the infected control cucumber has not even sprouted. In the batches subjected to no heat treatment and in the batches heat treated at 80° C. only 1-2 plants/test square remained alive upon expiration of trials. Batches heat treated at 60° C. yielded 3-4 plants/test square. For all batches 6 repetitions were made. Abovementioned effects were confirmed in cauliflower. These results are indicative of the fact that plant disease-suppressive activity stimulating effect observed in air-dried Sphagnum biomass strengthens upon impact treating thereof at 50-80° C.

Harvested and (optionally) pre-dried Sphagnum biomass feedstocks are normally provided in the form of mounds or clusters (clustered fragments comprising roots, stems, leaves, etc. and dimensioned 10-30 cm). The method further provides for reducing size of said mounds or clusters prior to heat treatment; thereupon a fibrous particulate with particle size at most 40 mm is formed. Downsizing may be performed by any appropriate method, such as disintegrating, crushing, grinding, shredding, cutting, chopping, and the like, and utilizing a conventional disintegrator or crusher, such as a hammer mill or a (wood) chopper, for example.

Fibrous particulate with particle size at most 40 mm can be further subjected to heat treatment, as discussed hereinabove. Heat treated fibrous particulate is further classified by particle size thereof to form a number of fractions with particle size distribution within any one of the: 2-4 mm, 4-8 mm, 8-20 and 20-40 mm, accordingly. Classification may be performed by any appropriate method of separating particles by size, such as sieving, screening and the like.

Additionally or alternatively the heat treated fibrous particulate with particle size at most 40 mm can be subjected to further size reduction by the above described (conventional) methods, thereupon a fibrous particulate or a powder with particle size 0.1-20 mm is formed followed by classification to form the aforesaid fractions.

In some particularly preferred embodiment, the heat treated Sphagnum biomass, optionally downsized to form the fibrous particulate, is further subjected to size-reduction to form a powder with particle size 0.1-2 mm.

Generating and sorting (by particle size) heat treated Sphagnum biomass-derived products is beneficial for the manufacture of solid- and semi-solid growth substrates with varying coarseness and/or friability.

In the method disclosed hereby Sphagnum moss biomass is preferably selected from naturally occurring Sphagnum species (Sphagnum sp.), wherein “naturally occurring” refers to the Sphagnum species occurring in wild nature. Commonly occurring in Finland Sphagnum (S.) species are advantageously utilized including, but not limited to S. fuscum, S. magellanicum, S. riparium, S. papillosum, S. majus, S. angustifolium, S. flexuosum, S. warnstorfii, S. nemoreum, S. russowii, S. affine, S. centrale, S. palustre, S. balticum, S. rubellum, S. jensenii, S. cuspidatum, S. capillifolium, S. fimbriatum, S. molle, S. quinquefarium, S. subfulvum, S. subnitens, and any combination thereof. Naturally occurring mixed Sphagnum moss community blends can also be utilized.

In one preferred embodiment Sphagnum moss biomass essentially consists of S. fuscum (Rusty bogmoss).

Sphagnum moss typically reaches approximately 30 cm in depth, with regard to an outer “surface” of the moss carpet or growing tips of moss plants; and has a lowermost layer (at a depth 20-30 cm) that gives rise to peat formation, a middle layer (10-20 cm) and an uppermost layer (1-10 cm). It is thus preferred that Sphagnum biomass feedstock essentially consists of a so called middle layer and a lowermost layer of Sphagnum carpet, i.e. of vegetative parts of Sphagnum moss plants occurring at a depth between about 30 cm and about 10 cm from the growing tips of a moss plant. It is further preferred that said Sphagnum biomass essentially consists of the middle layer of Sphagnum carpet i.e. of vegetative parts of Sphagnum moss plants at a depth between about 10 cm and about 20 cm with regard to the growing tips of moss plants. During the course of investigation, which results are described in the present disclosure, it was observed that the aforesaid middle Sphagnum carpet layer demonstrates the most powerful disease-suppressive activity inducing and stimulating effect. In experimental trials conducted in cauliflower (infected by Alternaria sp. and Rhizoctonia sp.) and in cucumber (infected by Pythium sp) the best results were attained with the middle layer, and the worst results—with the uppermost layer (1-10 cm), accordingly.

The method disclosed hereby effectively induces and stimulates plant disease-suppressive activity in Sphagnum biomass. Thus, heat treated Sphagnum biomass and related products were shown to prevent or at least slow down occurrence and/or spreading of harmful effects caused by common soil-borne or seed-borne plant diseases. Soil-borne diseases refer hereby to a group of particular plant diseases that are transmitted by pathogens found in soil; whereas seed-borne diseases are that transmitted by seed. Common soil-borne plant diseases include e.g. damping-off and root-rot diseases caused by fungi Pythium, Phytophthora, Rhizoctonia, Alternaria, Fusarium, or any combination thereof Damping-off is a common name for an abrupt collapse and dying of seedlings caused by rotting of stem and root tissues at and below the soil surface. Common seed-borne diseases include e.g. Fusarium wilt caused by Fusarium oxysporum and Alternaria blight caused by Alternaria spp.

Furthermore, the method disclosed hereby is suitable for inducing and stimulating suppressive activity against fungal diseases and moulds, in particular, saprophytic moulds, in Sphagnum biomass. Aforesaid fungal diseases and moulds are closely related counterparts, wherein the latter one is caused by species of fungi or fungi-related organisms. For example, grey- and white mould, as well as powdery mildew and downy mildew, relate to most common (fungal) diseases that affect a wide range of plants. It should be noted that while mildew is a group of fungi-induced diseases that affect an aboveground part of a plant; mould-related (fungi-induced) diseases can affect both aboveground parts (e.g. stem, leaves) and underground parts (e.g. roots, root vegetables) of the plant.

Thus, the method disclosed hereby can be referred to as inducing and/or stimulating fungistatic activity in harvested Sphagnum biomass feedstocks treated by the present method, as well as in related products, accordingly, whereupon said treated feedstocks and related products acquire an ability to prevent and/or inhibit fungal diseases and saprophytic moulds growth therewithin.

However, the above described fungistatic effect has not been generally observed in peat and never in mineral wool, such Rockwool, for example. Hence, peat does not acquire, but loses its antifungal activity upon being steam-treated. This phenomenon may be at least partly anticipated by the fact that fungistatic activity observed in Sphagnum species is mediated by the active ingredients internal thereto and responsible for initiating defense mechanisms against pathogens; whereas fungistatic activity observed in peat is predominantly mediated by a plurality of microorganisms present therein. For example, counts of microbial populations in Sphagnum (calculated per solid matter) are 10⁻³-fold or even less, as compared to the same in peat. At present, there is no public data available on the elemental composition of Sphagnum species occurring in Finland (e.g. S. fuscum, etc.).

Thus, subjecting peat to heat treatment at temperatures above that occurring in nature (e.g. at 70° C.) results in at least partial deactivation of microorganisms contained therewithin. On the contrary, rapid dehydration of cellular tissue occurring upon heat treatment of harvested Sphagnum biomass by the method disclosed herein does not cause excessive heating thereof; instead, said cellular tissue acquires a cold-induced “hibernation” state after drying, possibly only slightly damaged and thus preserving all active ingredients unaltered. However, the above described fungistatic effect observed in Sphagnum , appears to demolish almost completely at the temperatures above 80° C., just in the same manner as observed for peat.

Thus, by inspecting uppermost layer of Sphagnum carpets during hot and dry summer season it may be assumed that harvested Sphagnum biomass possibly withstands drying at temperatures less than approximately 50° C. (e.g. 40-50° C. on sunshine) thereby its fungistatic activity remains essentially unchanged in comparison to that of living Sphagnum carpets. However, that Sphagnum biomass preserves and/or improves its fungistatic activity upon raising the (drying) temperature above 50° C. pertains to a phenomenon not readily explainable on the basis of the existing data (for peat, mineral wool, etc.).

It is further essential that the above described plant disease-suppressive activity stimulating effect (fungistatic effect) is durable. According to preliminary experimental data, fungistatic effect in heat treated Sphagnum biomass and related products is preserved during at least 6-12 months after the treatment, dependent on environmental factors, technical field (e.g. agriculture, horticulture, forestry), purpose (e.g. greenhouse-, open-field- or indoor/home planting) and/or product-related parameters.

In another aspect of the invention a plant disease-suppressive growing medium is provided, comprising Sphagnum moss biomass stimulated according to the method described hereinabove.

Said plant disease-suppressive growing medium is provided in the form of a fibrous particulate or a powder with particle size at most 40 mm; hereby referring to particle size distribution within a range of: 0.1-40 mm. In some embodiments the plant disease-suppressive growing medium is provided in the form of a fibrous particulate having particle size distribution selected from the group consisting of: 2-4 mm, 4-8 mm, 8-20 mm and 20-40 mm.

Provision of the growing media with different particle size distributions allows for efficient exploitation thereof in a variety of applications (e.g. seeding, growing, transplanting) that indeed require handling different target material (e.g. seeds, emerging plants/young seedlings or fully grown plants). Thus, the growing medium with particle size distribution within 20-40 mm is particularly advantageous for (trans)planting fully grown plants, such as cucumber or tomato, as well as for being spread under perennial plants and/or trees. Accordingly, the growing medium with particle size distribution within 8-20 mm is particularly advantageous for cultivating crops and growing seedlings. The growing medium with particle size distribution within 2-4 mm and 4-8 mm can be in turn exploited as a sowing substrate for seeds of different sizes (small seeds and large seeds in comparison to one another, accordingly).

In some further embodiment the plant disease-suppressive growing medium is provided in the form of a powder with particle size distribution within 0.1-2 mm. In fact, addition of the aforesaid plant disease-suppressive powder into a conventional growing substrate in an amount of about 2-5 wt-% (calculated per amount of dry matter) is sufficient to impart an antifungal and/or an anti-mould activity to the resulting substrate (see Example 7),

The latter embodiment allows for producing fine powders beneficial for horticultural cultivation. On the whole, particulate- or powdered. growing media are particularly suitable for distribution on vast areas, such as open fields, for example.

Aforesaid fibrous particulates and/or powders may be further compressed and/or densified, optionally in presence of additives, by conventional methods to form substantially solid substrate structures with varying appearance (in terms of dimensions, size and shape), density and mass/weight. Thus, in addition to growth substrates in the form of grain, granules, pellets, briquettes, etc., being particularly suitable as potting substrates, for example, a variety of layered structures, such as sheets, mats, boards, etc. can be produced.

In some embodiments, the plant disease-suppressive growing medium further comprises an at least one additive selected from the group consisting of: nutrients, fertilizers, calcium carbonate (provided as dolomite lime), biochar (charcoal generated upon pyrolysis of biomass), ash, peat, bark, sawdust, clay, perlite, binders, surfactants, or any combination thereof. In fact, any other appropriate additive may be utilized. Formation of semi-solid- or fluidic growth structures may be advantageously realized.

Aforesaid plant disease-suppressive growing medium preferably comprises Sphagnum moss biomass selected from naturally occurring Sphagnum species, in accordance to what is described hereinabove. In some preferred embodiment the plant disease-suppressive growing medium essentially consists of Sphagnum fuscum.

In a further aspect a seedbed is provided, comprising the plant disease-suppressive growing medium in accordance to what is described hereinabove. In preferred embodiments said seedbed may thus be provided in the form of a substantially solid growth substrate configured as a layered structure, such as a sheet, a mat, a board and the like, having predetermined dimensions (in terms of width, length and height aka thickness). The layered structure may thus be 0.5-100 cm thick. Said layered structure may be configured to form rolls. In some other embodiments said seedbed may be provided in the form of a layer consisting of or comprising fibrous particulate or a powder with particle size distribution within 0.1-2 mm, 2-4 mm, 4-8 mm, 8-20 mm and 20-40 mm. In some exemplary embodiment the seedbed may comprise conventional peat-derived growth substrate and the plant disease-suppressive powder with particle size distribution within 0.1-2 mm admixed thereto in an amount of about 2-5 wt-% (calculated per amount of dry matter).

Seedbed structures implemented according to any of the embodiments disclosed above can be utilized as around covers, for example.

In some additional embodiments said seedbed may be further provided in semi-solid or substantially fluidic form, by addition of binders and/or wetting agents thereto, for example.

In further aspect, use of the plant disease-suppressive growing medium, implemented according to any of the embodiments disclosed above, is provided as a fungus-, mould- and mildew prevention agent.

It is essential that the aforesaid plant disease-suppressive activity is preserved in the growing medium, disclosed hereby, independent on configuration of said media. Thus, for the growing media implemented according to any of the embodiments plant disease-suppressive activity stimulating effect in terms of preventing, in full or at least partially, the spread of contagious plant diseases, in particular, fungus-originated diseases, as well as mould- and mildew, is preserved.

By the way of an example, the seedbed configured as a layered structure or as a potting substrate comprising a plurality of granules/pellets may be used as a plant-disease preventive agent as such. Additionally, the growing medium configured as a fibrous particulate or a powder may be used as such or as a supplement admixed into a conventional growth substrate, such as a peat-derived substrate or mulch, for example. A conventional peat-derived substrate comprising about 10 vol-% of the plant disease-suppressive growing medium provided in the form of a fibrous particulate or a powder efficiently suppresses fungus-induced mould growth in vegetables.

In still further aspect, use of the plant disease-suppressive growing medium, implemented according to any of the embodiments disclosed above, is provided as an insulating material for indoors and outdoors. In some preferred embodiment the insulating material is configured as a thermal insulator for heat- and frost insulation purposes. Alternatively or additionally the insulator may be configured as an acoustic insulator. Such insulating materials can be advantageously exploited in any type of buildings, including, but not limited to industrial-, commercial- and/or residential building infrastructure.

The insulators can be provided in the form of the above described layered structures (sheets, mats, batty, panels, etc.), loose-fill materials (fibrous particulate or a powder), or narrow strips or filaments, for example. On the contrary to mineral wool insulates (e.g. Rockwool) that demonstrate no fungistatic effect, the plant disease-suppressive growing medium used as an insulating material has been shown to completely prevent or at least markedly reduce growth and proliferation of fungi and saprophytic moulds therewithin.

It is clear to a person skilled in the art that with the advancement of technology the basic ideas of the present invention are intended to cover various modifications included in the spirit and the scope thereof The invention and its embodiments are thus not limited to the examples described above; instead they may generally vary within the scope of the appended claims.

### EXAMPLES

The examples presented hereinbelow are understood to be illustrative of various embodiments of the present invention and not restrictive thereof and are non-limiting with respect to the scope of the invention.

Trials were conducted using as a feedstock naturally occurring mixed Sphagnum moss community blends, further referred to as Sphagnum biomass, collected in Parkano area, Finland. Sphagnum biomass feedstocks were allowed to air-dry and size-reduced to form particulate fractions with particle size at most 40 mm, and particulate fractions with particle size at most 20 mm. Air-drying (pre-drying) is applicable for all examples, unless explicitly stated otherwise. Moisture content of the size-reduced Sphagnum biomass was adjusted to reach field capacity value (75 vol-%) and/or irrigation threshold (35 vol-%), as describe in Example 8.

Heat treatment according to the method of the invention was conducted in a heating oven with a function of continuous air supply. Moisture content of a heat treated product (growing medium) was further adjusted to reach field capacity value (75 vol-%) for assessing fungistatic activity (Example 6). Heat treated growing media were further supplied with dolomite lime (4 g) and peat-derived fertilizes (2 g), as provided per IL of the growing media (Example 2.2). Specific weight of said growing medium constituted 35-40 g/L, unless otherwise provided.

Post-treatment cultivation- and moulding trials were conducted in a greenhouse facility at about 20° C. in conditions of constant relative humidity (about 70%). Aforesaid temperature and humidity related parameters are applicable to all examples citing the “greenhouse facility”.

In all examples air-dried (not heat treated) Sphagnum biomass was used as a positive control.

### Example 1

### Mould Development on a Peat-Derived Growth Substrate and the same Supplied with Air-Dried Sphagnum Biomass (Positive Control)

Procedure: Air-dried Sphagnum biomass (positive control) with particle size about 20 mm was admixed to a peat-derived growth substrate (Grow Board by Kekkilä; specific weight about 100 g/L) in proportions 0, 10, 25, 50 and 100 vol-%. Cultivation pots containing aforesaid batches were maintained sufficiently moist over the duration of trials. In the beginning of trials cinnamon mould (Chromelosporium fulvum; peat mould) was transferred into each pot from elsewhere.

Result: In the pots containing Sphagnum biomass in an amount of 50 vol-%, formation of mould was completely prevented; whereas in the pots containing the same in an amount of 25 vol-%, mould growth was markedly reduced. Pots containing only Sphagnum biomass (100 vol-%) developed no mould.

### Example 2

### Investigating Damping-Off Disease Caused by Alternaria in Cauliflower Seedlings

### Example 2.1

### Investigating Plant Disease-Suppressive Activity Effect of Air-Dried Sphagnum Biomass (Positive Control) in Disinfected Peat

Procedure: Cauliflower seeds were infected by Alternaria brassicicola followed by planting said seeds into a growth substrate containing autoclave-disinfected (corresponds to conventional 1 hour steaming) peat and air-dried Sphagnum biomass with particle size about 20 mm (positive control) in proportions 0, 10, 25, 50 ja 100%. Seeds were infected by dipping into A. brassicicola aqueous suspension (1 PDA (Potato Dextrose Agar) plate/100 ml water).

Result: In concentrations 10 to 50 vol-%, and 100 vol-% Sphagnum biomass markedly reduced the symptoms caused by damping-off disease (Table 1), Trials conducted for 4 batches each containing 25 seeds.

TABLE 1
Plant disease-suppressive activity effect of air-dried Sphagnum
biomass admixed into disinfected peat in proportions
0, 10, 25, 50 ja 100%.
Disease rate: 0 = healthy, 2 = strong deterioration/number of plants

| Peat %/Sphagnum | | | | Damping-off, | Alive/100 |
|---|---|---|---|---|---|
| biomass % | 0 | 1 | 2 | % | seeds |
| 100/00 | 7 | 18 | 14 | 46 | 39 |
| 90/10 | 34 | 23 | 15 | 25 | 72 |
| 75/25 | 16 | 15 | 17 | 41 | 48 |
| 50/50 | 36 | 24 | 11 | 18 | 71 |
| 00/100 | 50 | 17 | 8 | 13 | 75 |
| Healthy seeds in | 95 | 0 | 0 | 2 | 95 |
| peat | | | | | |

### Example 2.2

### Investigating Plant Disease-Suppressive Activity Effect of Sphagnum Biomass Heat Treated According to One Aspect of the Invention, With Regard to Alternaria-Caused Diseases

Procedure: Sphagnum biomass feedstock was allowed to air-dry in a greenhouse facility at about 20° C., followed by size-reduction to form particulate fractions with particle size about 20 mm. Moisture content of size-reduced feedstock was adjusted to reach field capacity value (75 vol-%). Heat treatment (heating oven, air supply) was conducted at 70° C. during 2 days. Cauliflower seeds, pre-infected by A. brassicicola as described in the Example 2.1 and further dried between filter paper sheets during 2 days, were planted into thus obtained growing medium. Results were compared to that obtained by planting both healthy and infected seed into air-dried Sphagnum biomass (positive control, see Example 2.1). In some trials Sphagnum biomass was further supplied, prior to heat treatment, with lime and fertilizer, or only by lime. In the other trials liming was performed after heat treatment.

Result: Heat treating Sphagnum biomass at 70° C. markedly improved plant disease-suppressive activity. In comparison with positive control (air-dried Sphagnum biomass), plant disease-suppressive activity of heat treated Sphagnum biomass preserved substantially unchanged (Tables 2, 3). Liming of Sphagnum biomass prior to heat treatment does not reduce disease-preventive activity as compared to positive control. Liming also appears to prohibit further increase in the disease-preventive activity during heat treatment executed at 70° C. (Table 3).

TABLE 2
Influence of heat treatment (70° C., 2 days) on a survival rate of
cauliflower seedlings in comparison to positive control. Three
repetitions/25 seeds each.

| | Batch | | |
|---|---|---|---|
| Post-germination | 1 | 2 | 3 |
| period | Seedlings alive, % | | |
| 10 days | 56.0 | 49.3 | 97.3 |
| 2 weeks | 56.0 | 52.0 | 97.3 |
| 3 weeks | 53.3 | 48.0 | 97.3 |

Legend:
1. Positive control (A): air-dried Sphagnum biomass with particle size 20 mm + infected seed (C), PDA/100 ml.
2. Heat treated at 70° C. Sphagnum biomass (B) + infected seed (C), PDA/100 ml. 3. A + healthy seed.

TABLE 3
Effect imposed by time point of liming and fertilizing onto the plant
disease-suppressive activity of Sphagnum biomass heat treated at
70° C. Four repetitions/16 seeds each.

| | Batch | | | | |
|---|---|---|---|---|---|
| Post-germination | 1 | 2 | 3 | 4 | 5 |
| period | Seedlings alive, % | | | | |
| 10 days | 62.5 | 84.4 | 84.4 | 95.3 | 100.0 |
| 17 days | 65.6 | 93.8 | 81.3 | 79.7 | 100.0 |
| 5 weeks | 54.7 | 85.9 | 57.8 | 59.4 | 98.4 |

Legend:
1. Positive control: air-dried Sphagnum biomass with particle size 20 mm, liming and fertilizing are performed along with the moisture content adjustment + infected seed.
2. Heat treated at 70° C. Sphagnum biomass, liming and fertilizing are performed after heat treatment + infected seed.
3. Heat treated at 70° C. Sphagnum biomass, liming is performed before heat treatment and fertilizing is performed after heat treatment + infected seed.
4. Heat treated at 70° C. Sphagnum biomass, liming and fertilizing are performed before heat treatment + infected seed.
5. Positive control as in (1), liming and fertilizing are performed along with the moisture content adjustment + healthy seed.

### Example 3

### Mould Development in Air-Dried Sphagnum Biomass (Positive Control)

Procedure: Air-dried Sphagnum biomass (positive control) with particle size about 20 mm was placed into 50 mm cultivation cells that were kept in a greenhouse facility for 1 month. Mould development in samples has been examined three times by stereomicroscopic methods.

Result: No visible signs of mould development were observed during trials, Microscopic examination revealed presence of sparse mycelia occurring between Sphagnum particles, which mycelia did not form reproductive organs. Vegetative resides present in the examined Sphagnum samples and originating from hays and other Sphagnum -unrelated grasses were uncontaminated in the interior of the Sphagnum sample bulk. However, those vegetative resides located on the surface of said samples and forming no direct contact with Sphagnum particles had developed mould caused by Penicillium. Nevertheless, these fungi developed no growth populations into neighboring areas.

### Example 4

### Heat Treatment of Sphagnum Biomass in Web-Based Pots

Procedure: A number of 0.61. cultivation pots having a bottom/base made of web, each containing 3-4 dl of air-dried Sphagnum biomass, were prepared. Some pots contained Sphagnum biomass not subjected to size reduction; and some pots contained the same with particle size about 20 mm. Aforesaid pots were heat treated during 1 day and 2 days, at 40, 50, 60, ja 70° C. Each heat treatment was reproduced with 10 pots. After heat treatment the pots were kept in a greenhouse facility in conditions of daily moistening for 2 months. Prior to aforesaid incubation cinnamon mould was inoculated into all pots with inoculate obtained from moulds collected from the (moulded) commercial peat-derived growing substrates (Grow Board by Kekkilä). Mould development in the Sphagnum batches was evaluated weekly.

Result: After expiration of the trial period (2 months) all heat treated batches were mould-free.

### Example 5

### Comparison of the Sphagnum Biomass Heat Treated at 70° C. in Presence and Absence of Air

Procedure: A number of 10 L containers were prepared with about 3L of Sphagnum biomass placed into each container. Containers of a first type had solid bottom and sidewalls made of web to enable air supply. Containers of a second type (e.g. buckets) had solid bottom and solid sidewalls; additionally, top openings thereof were sealed with a plastic film in order to preserve moist during treatment. Heat treatment was conducted at 70° C. (2 days), thereafter Sphagnum biomass was disposed into 50 mm cultivation cells and kept in conditions of a greenhouse facility.

Result: In Sphagnum biomass heat treated in the sealed containers prominent and uniformly grown mould caused by Penicillium was observed already after 3 days of incubation. Sphagnum biomass heat treated in the containers allowing for air circulation demonstrated slight signs of mould growth only after 1 month of incubation.

### Example 6

### Investigating Plant Disease-Suppressive Activity Effect of the Sphagnum Biomass Heat Treated According to One Aspect of the Invention, With Regard to Pythium-Caused Diseases

Procedure: Heat treatment at 70° C. (2 days) was conducted on a number of 3 L Sphagnum biomass batches (particle size 20 mm) as described in Example 5. Thereafter moisture content in the 10 L containers was adjusted to reach field capacity value (75 vol-%), followed by inoculating resulted growing media with Pythium ultimum known to cause damping-off and root-rot diseases in seedlings. From each container three 0.6 L cultivation pots were prepared and 5 cucumber seeds were planted into each pot, In some trials heat treated. growing media additionally contained oat flour (5 g/L) (Table 4).

Infected Sphagnum biomass-derived growing medium was further applied in a flange-like manner around recently emerged cucumber seedlings planted into peat-derived growing media containing pots (negative controls), optionally comprising oat flour (5 g/L) (Table 5).

Result: Cucumber seeds planted into Sphagnum biomass heat treated in an absence of air (in sealed containers) either failed to emerge or collapsed very soon after emergency (Table 4). In Sphagnum biomass heat treated in presence of air (containers with sidewalls made of web) significantly more seedlings emerged in comparison to the “wet” growing medium. In Sphagnum biomass heat treated at 70° C. in presence of air all seeds produced seedlings that preserved healthy for 1.5 weeks, thereafter a part of the seedlings fell over because of damping-off (Table 4).

In the growing medium comprising air-dried Sphagnum biomass (positive control) about a half of all seeds sprouted/produced seedlings that got infected soon after emergency at a very young age.

Infected Sphagnum biomass applied around seedlings that recently emerged in the pots containing heat treated peat-derived growing media (without oat flour) caused no disease. Addition of oat flour into heat treated Sphagnum biomass-derived growing media resulted in damping-off. However, the disease developed to a lowest extent in the batches heat treated at 70° C. (Table 5).

TABLE 4
Damping-off disease caused by Pythium in cucumber planted
into growing media (particle size 20 mm) produced by heat treating
Sphagnum biomass at 70° C. (2 days) and in peat-derived
growing media. All growing media inoculated with Pythium 7 days
before seeding. Batches comprise 0.6 L pots each planted with 5
cucumber seeds; 3 repetitions/batch. Numerical values refer to an
average number of seedlings per batch.

Observation dates

| | | |
|---|---|---|
| 6.4.2014 | 8.4.2014 | 16.4.2014 |
| Emerged | Healthy | Healthy |

Growing medium without oat flour

| | | | |
|---|---|---|---|
| Air-dried Sphagnum | 2.0 | 0.0 | 0.0 |
| (positive control) | | | |
| Heat treated Sphagnum, | 5.0 | 5.0 | 2.0 |
| 70° C. | | | |
| Heat-treated peat, 70° C. | 2.3 | 0.0 | 0.0 |
| (negative control) | | | |

Growing medium comprising oat flour 5 g/l

| | | | |
|---|---|---|---|
| Air-dried Sphagnum | 0.0 | 0.0 | 0.0 |
| (positive control) | | | |
| Heat treated Sphagnum, | 0.0 | 0.0 | 0.0 |
| 70° C. | | | |
| Heat-treated peat, 70° C. | 0.0 | 0.0 | 0.0 |
| (negative control) | | | |

TABLE 5
Damping-off disease caused by Pythium in cucumber planted into
growing media (particle size 20 mm) produced by heat treating
Sphagnum biomass at 70° C. (2 days) and in peat-derived
growing media. All growing media inoculated with Pythium 7 days
before seeding. Inoculated growing medium applied on Apr. 1, 2014
around recently emerged seedlings grown on healthy peat-derived
growing media. Batches comprise 0.6 L pots each planted with 10
cucumber seeds. Numerical values refer to a number of healthy
seedlings per 10 pots.

| Observation dates | | | |
|---|---|---|---|
| 4.4.2014 | 5.4.2014 | 6.4.2014 | 8.4.2014 |

Growing medium without oat flour

| | | | | |
|---|---|---|---|---|
| Air-dried Sphagnum | 10 | 10 | 10 | 10 |
| (positive control) | | | | |
| Heat treated Sphagnum, | 10 | 10 | 10 | 9 |
| 70° C. | | | | |
| Heat-treated peat, 70° C. | 10 | 10 | 10 | 10 |
| (negative control) | | | | |

Growing medium comprising oat flour 5 g/l

| | | | | |
|---|---|---|---|---|
| Air-dried Sphagnum | 3 | 0 | 0 | 0 |
| (positive control) | | | | |
| Heat treated Sphagnum, | 6 | 3 | 3 | 0 |
| 70° C. | | | | |
| Heat-treated peat, 70° C. | 3 | 0 | 0 | 0 |
| (negative control) | | | | |

### Example 7

### Plant Disease-Suppressive Growing Medium in the Form of a Powder

Procedure: Sphagnum biomass was placed into about 10 L containers having solid bottom and web-made sidewalls to enable air supply and heat treated at 70° C. for 2 days. After heat treatment the lowest layer of biomass in the container seemed to preserve some moist. Heat treated Sphagnum biomass was size-reduced in a hammer mill followed by sieving to produce fine powder (with particle size distribution 0.1-2 mm). Two test runs were carried out as follows. In a first test run 5, 10 and 50 g of thus obtained powder were distributed along a surface of a peat-derived Grow Board by Kekkilä(0.25 wt-%, 0.5 wt-% and 2.5 wt-% with regard to the amount of peat, accordingly). In a second test run the aforesaid commercial peat-derived board was disintegrated to form loose particulate and Sphagnum -derived powder was admixed thereto (1 g, 10 g and 100 g/kg). Resulted composites were moistened and placed into greenhouse facility conditions. Generation and growth of cinnamon mould were evaluated during one month time-period.

Result: Sphagnum biomass-derived powder distributed on or admixed to conventional growing media in the aforesaid amounts reduced generation of mould.

### Example 8

### Influence of Initial Moisture Content in the Sphagnum Biomass on Fungistatic Activity Thereof

Procedure: Moisture content in Sphagnum biomass was adjusted to reach the following values: 1. 15 vol-% (air-dry); 2. 35 vol-% (irrigation threshold; =−50 cm: water potential); and 3. 75 vol-% (field capacity; −10 cm: water potential). Heat treatment was conducted thereafter at temperatures 50, 60, 70 and 80° C. in sealed containers and in containers with web-made sidewalls, as described in previous examples. After heat treatment the lowest layer of biomass in the container seemed to preserve sonic moist. Two test runs were carried out in accordance to what is described in Example 6 (Pythium test) and in Example 4 (cinnamon mould test); however, inoculation with cinnamon mould was performed by transferring a fingernail-sized transplant from a mouldy peat-derived growth substrate (Grow Board by Kekkilä) onto Sphagnum biomass. Each test was conducted in three pots containing five cucumber seeds per pot. Three repetitions per each pot were made. At the end of trials fresh weight was determined for all seedlings.

Result: Pythium tests demonstrated differences in seedlings' emergency rates and subsequent occurrence of damping-off. Damping-off rate was the highest in Sphagnum biomass heat treated in sealed containers. The greatest emergency rate (100%) and the highest number of healthy seedlings/per pot (3.3) were observed in open containers heat treated at 70° C., whose initial moisture content constituted 35 vol-%. At 80° C. and with the same moisture content the number of seedlings/per pot was 1.4. In all trials Pythium-caused weakening in seedlings' growth was observed, as compared to the results obtained from the non-infected Sphagnum biomass-derived growing medium (positive control). See Tables 6 and 7.

TABLE 6
Development of mould, amount of cucumber seedlings
and weight thereof observed in the Sphagnum biomass
air-dried (positive control) and heat treated at different
temperatures and in varying conditions of air supply.

| | Surface | Emerged | Emerged |
|---|---|---|---|
| | moulding | seedlings | seedlings |
| | 0-5 | g/seedling | % |
| Heat treatment | | | |
| Open container | 1.25 | 4.74 | 89.86 |
| Sealed container | 2.31 | 4.31 | 81.70 |
| Moisture content | | | |
| in the Sphagnum | | | |
| biomass before | | | |
| heat treatment | | | |
| 15 vol-% | 1.08 | 4.63 | 87.92 |
| 35 vol-% | 1.50 | 4.88 | 92.66 |
| 75 vol-% | 1.17 | 4.69 | 89.00 |
| Heat treatment, | | | |
| temperature | | | |
| 50° C. | 0.56 | 4.70 | 89.15 |
| 60° C. | 2.00 | 4.71 | 89.39 |
| 70° C. | 1.44 | 4.73 | 89.82 |
| 80° C. | 0.56 | 4.70 | 89.15 |
| Air-dried Sphagnum | 0.00 | 5.27 | 100 |
| biomass (positive | | | |
| control) | | | |

TABLE 7
Evaluating amount, weight and health of recently emerged
and two-week old cucumber seedlings planted in the growing
media derived from the Sphagnum biomass at different
temperatures and in varying conditions of air supply. Inoculation
with Pythium performed after heat treatment, but one week before
inserting seeds into growing media.

| | Emerged | Number and weight of regular seedlings | | |
|---|---|---|---|---|
| | seedlings | Healthy | | |
| | seedlings/ | seedlings/ | | |
| | treatment | treatment | g/test square | g/plant |
| Heat treatment | | | | |
| Open container | 3.36 | 2.75 | 9.33 | 3.31 |
| Sealed container | 2.67 | 2.31 | 6.94 | 2.72 |
| Moisture content | | | | |
| in the Sphagnum | | | | |
| biomass before | | | | |
| heat treatment | | | | |
| 15 vol-% | 3.08 | 2.33 | 7.08 | 3.06 |
| 35 vol-% | 3.50 | 3.33 | 11.75 | 3.48 |
| 75 vol-% | 3.50 | 2.58 | 9.17 | 3.39 |
| Heat treatment, | | | | |
| temperature | | | | |
| 50° C. | 1.78 | 1.44 | 4.56 | 3.11 |
| 60° C. | 3.89 | 2.78 | 8.67 | 3.10 |
| 70° C. | 3.67 | 3.33 | 12.22 | 3.62 |
| 80° C. | 1.78 | 1.44 | 4.56 | 3.11 |
| Air-dried Sphagnum | 5.00 | 5.00 | 26.33 | 5.27 |
| biomass (positive | | | | |
| control) | | | | |

### Example 9

### Investigating Plant Disease-Suppressive Activity Effect of the Air-Dried Sphagnum Biomass Heat Treated at Temperatures 40-80° C.

Trials in cucumber: Heat treatment at temperatures 40, 50, 60, 70 and 80° C. was conducted on air-dried Sphagnum biomass batches (moisture content 10-15 vol-%) during 12 hours. Heat treated Sphagnum batches were subjected to moistening, liming and fertilization, followed by inoculation with an aqueous suspension of Pythium ultimum 7 days before seeding (40 g of Sphagnum biomass per a 9 cm PDA plate). White horticultural peat substrate was used as a healthy control. The same peat substrate inoculated P. ultimum and disinfected during 12 hours at 80° C. (1 L of peat substrate per batch) was used as an infected control, Sphagnum biomass was kept in conditions of a greenhouse facility at 20° C. and daylight duration 12 hours.

Trials in cauliflower: Heat treatment conditions and utilized growing media were the same as described above. Cauliflower seeds were inoculated with an aqueous suspension of Alternaria brassicicola (1 PDA plate/100 ml water). Each test square comprised 14 seedling trays (5 cm) each containing 0.5 dl of growing medium.

Result: For cucumber, all seeds in the healthy control emerged and remained healthy until expiration of the trials (see Table 8), On the contrary, no germination occurred in the infected control. All heat treated Sphagnum batches contained seedlings, a part of which remained alive until expiration of trials. Sphagnum batches heat treated at 60° C. contained significantly more seedlings of considerably greater size.

For cauliflower, the infected control contained significantly less seedlings eligible for planting, as compared to the heat treated Sphagnum batches. The most lightweight seedlings were observed in the Sphagnum batches treated at 80° C. (see Table 9).

TABLE 8
Amount, fresh weight and root morbidity of cucumber seedlings
observed in the Sphagnum biomass air-dried and heat treated at
various temperatures during 12 hours. All growing media inoculated
with Pythium ultimum 7 days before seeding. Trial duration was
25 days.

| | | | | Root |
|---|---|---|---|---|
| | Germinated, | Plants alive at the | | morbidity |
| | number/test | end of the trials, | Fresh weight, | rate 0-3/ |
| Batch | square | number/test square | g/test square | test square |
| 0 | 5.0 | 5.0 | 50.1 | 0.0 |
| 1 | 0.0 | 0.0 | 0.0 | 3.0 |
| 2 | 2.5 | 1.5 | 9.4 | 1.7 |
| 3 | 3.5 | 2.3 | 16.8 | 1.0 |
| 4 | 3.8 | 3.2 | 25.6 | 1.0 |
| 5 | 2.2 | 1.5 | 11.8 | 1.3 |
| 6 | 2.2 | 1.2 | 9.5 | 1.7 |

Legend (batches):
0. Peat, healthy control.
1. Peat, infected control.
2. Sphagnum, 40° C.
3. Sphagnum, 50° C.
4. Sphagnum, 60° C.
5. Sphagnum, 70° C.
6. Sphagnum. 80° C.
Each batch contained 6 repetitions and each test square contained 5 seeds.

TABLE 9
Amount of cauliflower seedlings eligible for planting and an
average fresh weight thereof observed in Sphagnum biomass
air-dried and heat treated at various temperatures during 12 hours.
Seeds were inoculated with A. brassicicola. Trial duration was 26 days.

| | Seedlings eligible for planting, | |
|---|---|---|
| Batch | number/test square | Average weight of a seedling, g |
| 0 | 13.4 | 3.17 |
| 1 | 8.0 | 3.03 |
| 2 | 11.2 | 2.89 |
| 3 | 11.0 | 3.07 |
| 4 | 12.2 | 3.00 |
| 5 | 11.0 | 2.81 |
| 6 | 11.4 | 2.60 |

Legend (batches):
0. Peat, healthy control.
1. Peat, infected control.
2. Sphagnum, 40° C.
3. Sphagnum, 50° C.
4. Sphagnum, 60° C.
5. Sphagnum, 70° C.
6. Sphagnum, 80° C.
Each batch contained 5 repetitions and each test square contained 14 seeds (in 5 cm seedling trays).

1. A method for stimulating plant disease-suppressive activity in Sphagnum moss biomass, wherein in said method Sphagnum moss biomass is heat treated, thereupon a flow of air heated to a temperature within a range of 50-80° C. is conveyed to Sphagnum moss biomass during a predetermined period of time.

2. The method of claim 1, wherein said Sphagnum moss biomass is freshly harvested and/or allowed to air-dry at a temperature less than 50° C. prior to heat treatment.

3. The method of claims 1, wherein the time period for heat treatment of Sphagnum moss biomass is 0.01-24 hours.

4. The method of claim 1, further comprising subjecting Sphagnum moss biomass to size reduction prior to heat treatment, thereupon a fibrous particulate with particle size at most 40 mm is formed.

5. The method of claim 1, further comprising classifying the heat treated fibrous particulate by particle size thereof to form a number of fractions with particle size distribution within any one of the: 2-4 mm, 4-8 mm, 8-20 and 20-40 mm.

6. The method of claim 1, further comprising subjecting heat treated Sphagnum moss biomass to size reduction, thereupon a powder with particle size distribution within 0.1-2 mm is formed.

7. The method of claim 1, wherein Sphagnum moss biomass is selected from naturally occurring Sphagnum species and naturally occurring mixed Sphagnum moss community blends.

8. The method of claim 1, wherein Sphagnum moss biomass essentially consists of Sphagnum fuscum.

9. The method of claim 1, wherein Sphagnum moss biomass essentially consists of vegetative parts of Sphagnum moss plants occurring at a depth between about 30 cm and about 10 cm.

10. The method of claim 1, wherein plant disease-suppressive activity is at least soil-borne- and seed-borne fungal disease-suppressive activity and saprophytic mould-suppressive activity.

11. A plant disease-suppressive growing medium comprising Sphagnum moss biomass stimulated according to the method defined in claim 1, wherein said plant disease-suppressive growing medium is provided in the form of a fibrous particulate or a powder with particle size at most 40 mm.

12. The plant disease-suppressive growing medium of claim 11 in the form of a fibrous particulate having particle size distribution selected from the group consisting of: 2-4 mm, 4-8 mm, 8-20 mm and 20-40 mm.

13. The plant disease-suppressive growing medium of claim 11 in the form of a powder with particle size distribution 0.1-2 mm.

14. The plant disease-suppressive growing medium of claim 11, comprising Sphagnum moss biomass selected from naturally occurring Sphagnum species and naturally occurring mixed Sphagnum moss community blends.

15. The plant disease-suppressive growing medium of claim 11, comprising Sphagnum moss biomass that essentially consists of Sphagnum fuscum.

16. The plant disease-suppressive growing medium of claim 11, further comprising an at least one additive selected from the group consisting of: nutrients, fertilizers, biochar, bio-ash, peat, bark, sawdust, clay, perlite, binders, surfactants, or any combination thereof.

17. A seedbed comprising the plant disease-suppressive growing medium as defined in claim 11.

18. A fungus-, mold- and/or mildew prevention agent comprising the plant disease-suppressive growing medium according to claim 11.

19. An insulating material comprising the plant disease-suppressive growing medium according to claim 11.

20. The method of claim 2, wherein the time period for heat treatment of Sphagnum moss biomass is 0.01-24 hours.
